(19) United States
(12) Patent Application Publication
(10) Pub. No.: US 2014/0101548 A1
(43) Pub. Date: Apr. 10, 2014

(54) CONCURRENTLY PRESENTING INTERACTIVE INVITATIONAL CONTENT AND MEDIA ITEMS WITHIN A MEDIA STATION THROUGH THE USE OF BUMPER CONTENT

(71) Applicant: APPLE INC., Cupertino, CA (US)

(72) Inventors: Thomas Alsina, Mountain View, CA (US); Scott Forstall, Cupertino, CA (US); Eswar Priyadarshan, Los Altos, CA (US); Jayasurya Vadrevu, Saratoga, CA (US); Lucas Newman, San Francisco, CA (US); Todd Michael Teresi, Los Gatos, CA (US); Scott Witt, Brooklyn, NY (US); Jason James St. Pierre, Palo Alto, CA (US); Kenley Sun, Cupertino, CA (US)

(73) Assignee: Apple Inc., Cupertino, CA (US)

(21) Appl. No.: 13/646,558

(22) Filed: Oct. 5, 2012

(51) Int. Cl. G06F 3/01

(52) U.S. Cl. 715/717

(57) ABSTRACT

A media channel can include a mix of media items and invitational content packages. At some point during the playback of the media channel, an invitational content package can be presented. In response to detecting the occurrence of an interactive segment triggering event during the presentation of the invitational content package, an invitational content interactive segment and a next media item can be simultaneously presented. This can be accomplished by splitting the media channel into multiple streams, such as an audio stream and a visual stream, and presenting an element of the interactive segment within a first stream and an element of the media item within a second stream. To decrease the likelihood that a user may equate the invitational content with the media item, a bumper content item, such as audio that says, “now back to the music,” can be presented just prior to playback of the media item.

### BACKGROUND

1. Technical Field

The present disclosure relates to presenting invitational content and more specifically to concurrently presenting interactive invitational content and media items within a media station on a client device in a manner that creates a differentiation between a media item and a concurrently presented invitational content item.

2. Introduction

Many users enjoy consuming content such as music or television shows without having to purchase or maintain a copy of the media items. Traditionally, users accomplished this through radio or television broadcasting. However, many users have turned to more flexible content distribution and consumption models offered through the Internet and portable electronic devices, such as media streaming services. Such services allow a user to stream an individual content sequence to an Internet connected device. While each individual user of the media streaming service is not required to purchase a copy of the media items consumed, the media streaming service is generally required to pay a fee to the content providers. In order to fund a media streaming service a number of new revenue models have been developed, many of which include presenting invitational content, such as advertisements within the media stream. The presentation of invitational content allows a media streaming service to offer the media items to a consumer at a significantly reduced rate or even for free.

Traditionally, invitational content has been presented within a media stream by inserting it between media items or by presenting it overtop of a media item. For example, an audio advertisement may be presented in between two songs, such that playback of the second song is prevented until the audio advertisement completes. In another example, a banner advertisement may be presented across the top or bottom of a television show. Such techniques rely on more traditional invitational content presentation models that can be highly static, and thus not engaging the user. For example, many users may simply ignore static content, such as an audio advertisement, presented between media items because the content does not invite the user to engage and learn more about the offer or item being presented. Additionally, any interactive features associated with the invitational content requires the user to at least temporarily discontinue playback of a media item to interact with the invitational content. For example, many users may choose not to engage with interactive content, such as a banner advertisement, even when interested in the offer or item presented because further exploration will, at least temporarily, discontinue playback of the media stream. This decreases the benefits available to both invitational content providers and consumers.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for presenting invitational content within a media channel. A media station can be a mix of media items and invitational content packages that can be played or executed by a media station player on a client device. At some point during the playback of the media station, an invitational content package can be presented. In some cases, an invitational content package can be presented to a user in a manner that prevents or blocks the playback of a next media item or a next segment of a media item. An invitational content package can include a fixed sequence segment and an interactive segment. A fixed sequence segment can include an audio element, a visual element, and/or an interactive triggering element. The interactive segment triggering element can be associated with one or more predefined interaction events, such as a tap, click, predefined movement, or audio command. When the predefined interaction event occurs, the presentation of the fixed sequence segment can be replaced with the simultaneous presentation of the variable sequence segment and playback of a media item within the media station. A variable sequence segment can include one or more sections of content where a user can interact with the different sections. For example, a variable sequence segment can be configured so a user can swipe through different images, scroll through text, activate audio or video components, provide feedback or other user input, etc.

In order to simultaneously present an invitational content package interactive segment and at least an element of a media item, the media channel can be split into multiple streams, such as an audio stream and a visual stream. Additionally, each media item can be split into multiple elements, such as an audio element and a visual element. By splitting the media channel into multiple streams, the interactive segment can be presented in one stream while at least an element of a media item is presented in the other stream. To prevent unintentional association between the invitational content of the interactive segment and the concurrently presenting media item, a bumper content item can be presented simultaneously with the interactive segment, but just prior to resuming playback of the media item. The bumper content can be a short, intermediary content item that transitions from the invitational content to the media item. For example, the bumper content can be audio that says, “now back to the music.” Upon completion of the bumper content item, an element of the media item can be presented.

In some configurations, an interactive segment can include both visual and audio content, such as an introductory audio clip presented in conjunction with visual elements or a video segment that is activated by a user action. In such a configuration, the interactive segment can prevent playback of a media item until a stream of the media channel is clear. In some cases, multiple elements can be active immediately upon presentation of the interactive segment, but one element can complete playback prior to the other element. When the first element completes playback a stream will be left empty. The empty stream can be used to play back an element of a next media item. Instead of immediately beginning playback of an element of a next media item within the empty stream, a bumper content item can be presented. Upon completion of playback of the bumper content item, the element of the next media item can then be presented.

Additionally, in some cases, user interaction with a currently presented interactive segment can activate a feature of the interactive segment that requires use of an additional stream. The interactive segment 606 can include one or more interactive features and one or more element triggering events, such as an audio element triggering event and/or a visual element triggering event. An element triggering event can include a tap, a click, a predefined movement of the client device, an audio command, etc. The occurrence of an element triggering event can indicate that the interactive segment will require use of multiple streams of the media channel. Additionally, the occurrence of the element triggering event can preempt playback of any currently playing media item. For example, preemption can automatically pause playback of a media item audio element. Once playback completes on a stream, playback of the preempted content can resume. However, in some cases, prior to resuming playback of the paused content, a bumper content item can be played to create a transition between the invitational content and the media item. Upon completion of the bumper content item, the paused media item can resume playback.

In some cases, a single bumper content item can be used anytime a bumper content item is required, regardless of media station. However, in some configurations, bumper content can be customized. A bumper content item can be customized based on a number of factors, such as user characteristics, the current invitational content, a previously played media item, a next media item scheduled for playback, and/or characteristics of the media channel.

The selection and/or display of the bumper content within a media station can be based on one or more rules or constraints. A type of rule can be a bumper content playlist generation rule. A bumper content playlist generation rule can define which items of bumper content are candidates for playback on a particular media station. A variety of bumper content playlist generation rules are possible, such as rules defined by a media station sponsor, rules based on matching metadata, rules based on similarity to a seed item, rules based on user characteristics, and/or rules based on other criteria, e.g. genre, artist, media type, presentation type, bandwidth requirements, processor requirements, client device type, etc. Another type of rule can be a bumper content playback rule. A bumper content playback rule can define constraints on the playback order or any bumper content and/or whether a bumper content item should be played at all. A variety of bumper content playback rules are possible, as rules based on matching metadata, rules based on time, rules based on media item playback, and/or rules based on an event trigger.

In some configurations, a client device can request a media item, an invitational content package, and/or a bumper content item from a content server at the time that a content item is needed for playback. In this configuration, the content server can apply one or more content playlist rules and/or one or more content playback rules to identify a content item for the client device. Alternatively, content can be cached on a client device. In particular, the client device can cache a list of candidate bumper content items and one or more bumper content playback rules. In response to the occurrence of a bumper content triggering event, the client device can apply one or more content playback rules to the list of candidate bumper content items to identify a content item to add to the content stream of a media channel. A bumper content triggering event can include detecting an interactive segment triggering event within an invitational content package fixed sequence segment and/or completion of an element of an interactive segment while the other element remains active, e.g. completion of an interactive segment audio element while the interactive visual segment remains playing.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary an exemplary media station playback scenario;

FIG. 2 illustrates an exemplary media channel playback scenario with user interaction detailing the audio and visuals streams;

FIG. 3 illustrates an exemplary media channel playback scenario on a client device with user interaction;

FIG. 4 illustrates an exemplary media channel playback scenario that uses bumper content;

FIG. 5 illustrates an exemplary media channel playback scenario in which the interactive segment includes an audio component;

FIG. 6 illustrates an exemplary media channel playback scenario on a client device in which an interactive segment audio component can be triggered by user interaction;

FIG. 7 illustrates an exemplary media channel playback scenario detailing the audio and visual streams when a user triggers an interactive segment audio component;

FIG. 8 illustrates an exemplary configuration of devices and a network;

FIG. 9 illustrates an exemplary bumper content server configuration;

FIG. 10 illustrates an exemplary client device configuration;

FIG. 11 illustrates a first exemplary method for presenting interactive invitational content within a media channel;

FIG. 12 illustrates a second exemplary method for presenting interactive invitational content within a media channel;

FIG. 13 illustrates an exemplary method for selecting a bumper content item for playback within a media channel; and

FIG. 14 illustrates an exemplary system embodiment.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The present disclosure addresses the need in the art for an improved way to present invitational content within a media channel that can be consumed on a client device. A media channel or media station can be a sequence of media items that can be played or executed by a media station player on a client device. Some non-limiting examples of media items can include songs, podcasts, television shows, games, audiobooks, university courses, and/or videos. Other media items are also possible. The media station player can be any application capable of media item playback, such as a component of a webpage, a plug-in, a client-side application, etc. In some cases, a media station can be a continuous sequence of content such that as one content item completes playback a next item begins. The playback process of a continuous media stream can repeat until a user takes an action to terminate or temporarily delay the playback, such as quitting the application, switching to a different media station, pausing playback, or skipping a media item. However, a media station can also be defined to be a finite sequence of media items. A media station can be homogeneous or heterogeneous. That is, a media station can be designed to playback media items all of the same media type or of different media types. For example, a homogeneous media station can playback only audio media items or only video media items. In another example, a heterogeneous media station can playback a mix of audio media items and video media items.

A media station can also be configured to play invitational content, such as advertisements, within the media stream. An invitational content item can include content found in a media item, such as a song or a video, but an invitational content item can also include targeted content and/or content designed to elicit a response from a user. Therefore an invitational content item and a media item can be distinct item types, each of which can be presented in a media station. The invitational content can be used as a source of revenue and/or to subsidize a media station so that the media items can be provided to end users free of charge or for a reduced fee. The invitational content can be presented within a media station using a variety of techniques. In some cases, invitational content can be presented to a user in a manner that prevents or blocks the playback of a next media item or a next segment of a media item. For example, upon the completion of the playback of a music item, but before beginning playback of a new music item, an invitational content item can be presented in the media stream. Invitational content can also be displayed in conjunction with a media item or media item representation. For example, an invitational content item can be presented in a banner ad displayed with a music album cover or during the playback of a television show.

Using the present technology it is possible to increase the benefits to both consumers and providers of invitational content. An aspect of the present technology that aids in the improvement involves invitational content packages that include an interactive segment that can be presented concurrently with one or more media items. To accomplish this, an invitational content item can be an invitational content package, which can include a fixed sequence segment and/or a variable sequence segment, also referred to as an interactive segment. A fixed sequence segment can include an audio element, a visual element, and/or an interactive triggering element. For example, a fixed sequence segment can include a video, which when activated plays until completion or until a user terminates the video through some type of interaction. In another example, a fixed sequence segment can include audio and a still image that is displayed for the duration of the audio or until a user terminates the presentation through some type of interaction.

A fixed sequence segment terminating event can be an event that entirely terminates the presentation of the invitational content package, such as changing the media station or exiting the media station player. However, a terminating event can also be an interaction event, such as tapping or clicking on the invitational content, that corresponds to the interactive triggering element. The interactive segment triggering element can be associated with one or more predefined interaction events, such as a tap, click, predefined movement, or audio command. When the predefined interaction event occurs, the presentation of the fixed sequence segment can be replaced with the simultaneous presentation of the variable sequence segment and playback of a media item within the media station. A variable sequence segment can include one or more sections of content where a user can interact with the different sections. For example, a variable sequence segment can be configured so a user can swipe through different images, scroll through text, activate audio or video components, provide feedback or other user input, etc.

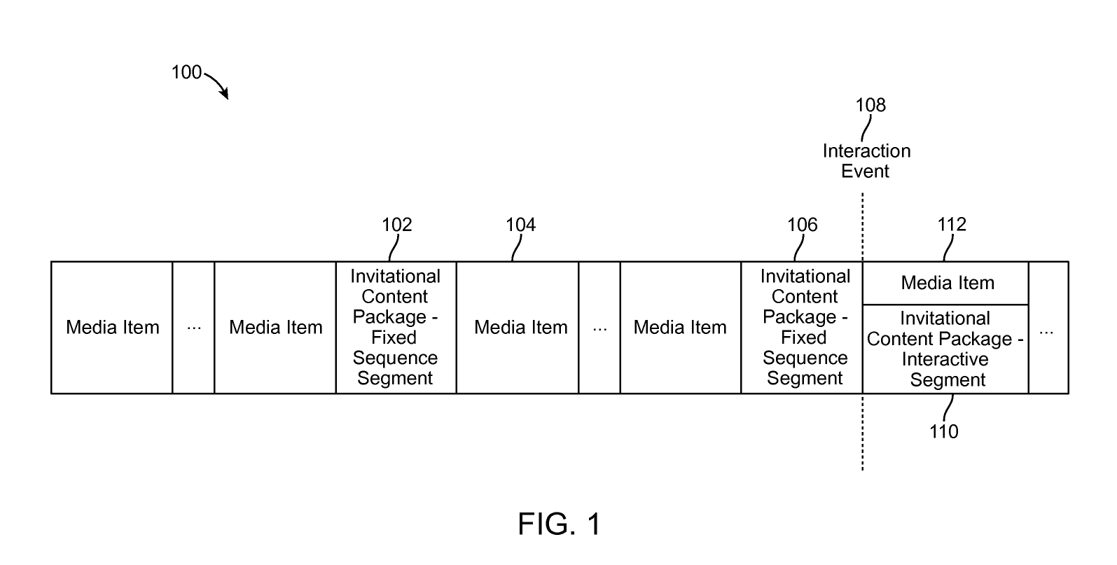

FIG. 1 illustrates an exemplary media channel playback scenario 100. The media channel can include a mixture of media items and invitational content packages. At various points during playback of the media channel, such as upon completed playback of a media item, an invitational content package can be presented, such as invitational content package 102. In some configurations, the placement and selection of invitational content items can be governed by a variety of invitational content playback rules.

In some cases, the invitational content package can be configured to initially present a fixed sequence segment 102, 106. Furthermore, the invitational content package can be presented in a manner that prevents playback of a next media item, such as media item 104, until the fixed sequence segment terminates. In some cases, the fixed sequence segment can terminate upon completion of a predefined period of time or completion of an audio or video segment. In this case, the media channel can continue playback with a next media item, such as media item 104.

However, as described above, the fixed sequence segment can also be terminated by an interactive segment triggering event, such as a user clicking on the displayed invitational content. For example, interaction event 108 can terminate the presentation of the invitational content package fixed sequence segment 106. In response to the interaction event 108, the invitational content package interactive segment 110 and a next media item 112 can be simultaneously presented within the media channel.

In order to simultaneously present an invitational content package interactive segment and at least an element of a media item, the media channel can be split into multiple streams, such as an audio stream and a visual stream. Additionally, each media item can be split into multiple elements, such as an audio element and a visual element. For example, a music item can include the audio for the song, as well as a visual element, such as an album cover. The album cover can be presented on a display on a client device via the media channel while the song is played on the media channel through an audio output. In another example, a television item can include the audio track that accompanies the video track. By splitting the media channel into multiple streams, the interactive segment can be presented in one stream while at least an element of a media item is presented in the other stream. For example, an interactive segment can be presented in the visual stream while a media item audio element is presented in the audio stream.

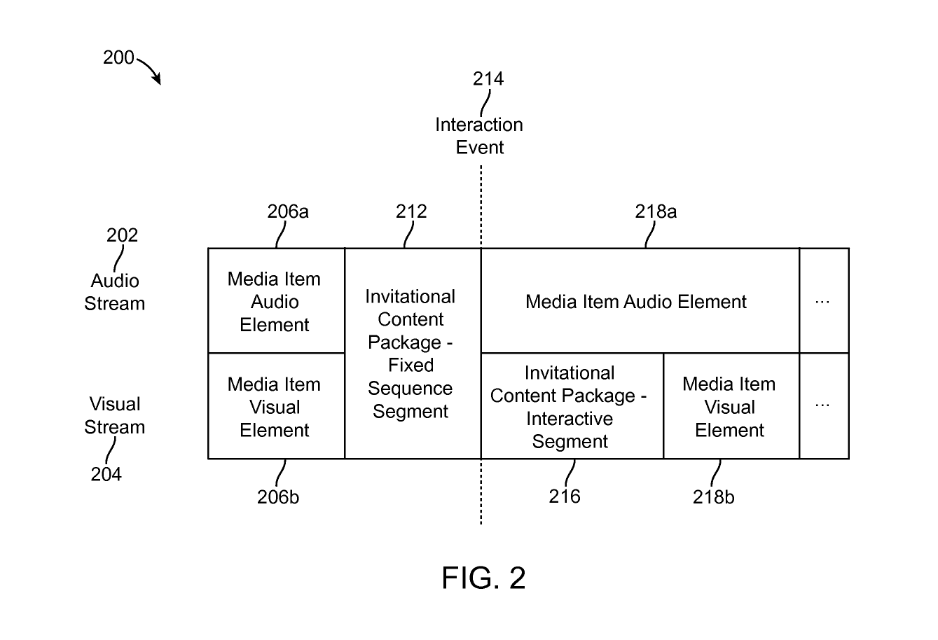

FIG. 2 illustrates an exemplary media channel playback scenario 200 with user interaction detailing the audio and visuals streams. The media channel can be split into an audio stream 202 and a visual stream 204. During standard playback of a media item, such as the media item made up of audio media item audio element 206a and media item visual element 206b, the audio element 206a can be presented in the audio stream 202 and the visual element 206b can be presented in the visual stream 204. At various points during playback of the media channel, an invitational content package can be presented within the media channel, such as invitational content package 212. In some configurations, the placement and selection of invitational content items can be governed by a variety of invitational content playback rules. The invitational content package 212 can also be configured to include multiple elements, such as an audio and a visual element, so that playback of the invitational content package 212 occupies the entire media channel, thereby preventing playback of a next media item.

In some cases, the invitational content package 212 can be configured to initially present a fixed sequence segment. In response to an interaction event, such as interaction event 214, presentation of the invitational content package fixed sequence segment can be terminated and the interactive segment can be presented within a stream of the media channel. In scenario 200, the interactive segment 216 is presented within the visual stream 204, leaving the audio stream empty. The empty audio stream can be filled with playback of a next audio item, such as media item audio element 218a. This split enables the concurrent playback of the media item audio element 218a and the invitational content package interactive segment 216.

At some point, playback of the interactive segment can terminate. In some cases, the interactive segment can be terminated through user interaction, such as through an exit or quit command. Alternatively, the interactive segment can terminate after a specified period of time or upon completion of a predefined playback sequence. Upon termination of the invitational content package interactive segment 216, the visual element of the currently playing media item can be presented, such as visual element 218b.

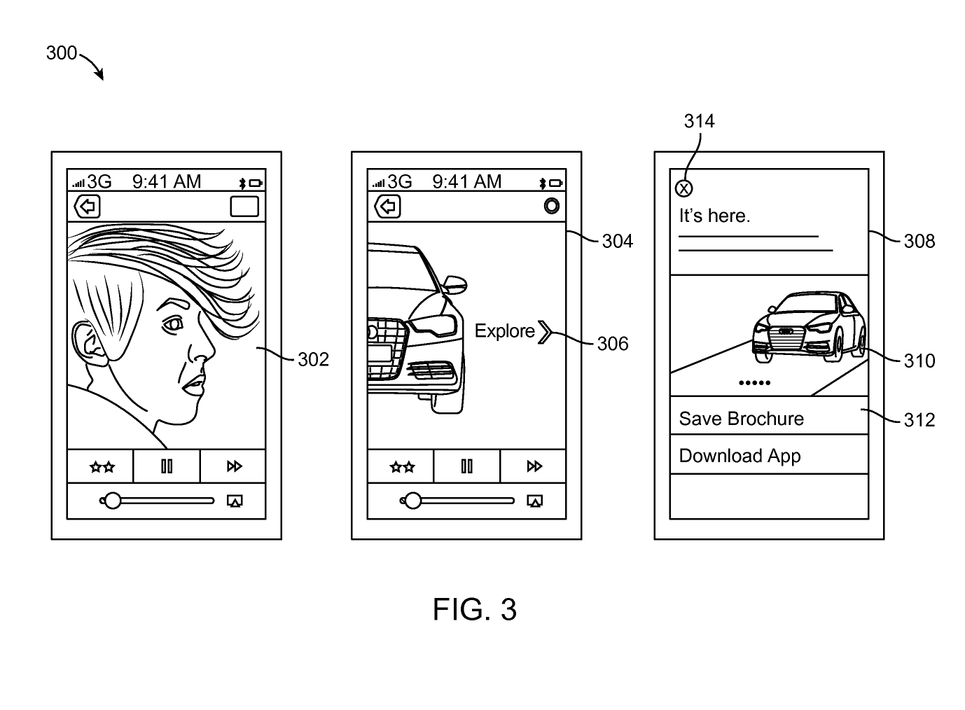

FIG. 3 illustrates an exemplary media channel playback scenario 300 on a client device with user interaction. A media item can be presented within the media channel. The media item can include an audio and a visual element, such as visual element 302. The audio element can be presented through an audio output, such a speaker, headphones, etc. The visual element, such as visual element 302, can be presented on the display of the client device. Upon completion of playback of the media item, an invitational content package can be presented within the media channel.

The invitational content package can also include an audio and a visual element and can be presented in a manner that prevents playback of a next media item. The audio element can be presented through the audio output. The visual element can be presented on the display of the client device. The invitational content package can be configured to initially present a fixed sequence segment, such as fixed sequence segment 304. The fixed sequence segment can be presented in place of any other visual item, as a layer over top of another visual item, next to another visual item, etc. The fixed sequence segment can also be associated with an interactive triggering event, such as a tap, click, movement of the client device, audio command, etc. For example, fixed sequence segment 304 is associated with a tap interactive triggering event at area 306.

In response to detecting by the client device the tap interactive triggering event 306, the fixed sequence segment 304 can be replaced within the media channel with an interactive segment, such as interactive segment 314. The interactive segment 314 can be presented on the display of the client device via the visual stream of the media channel. The interactive segment 314 can include one or more interactive features, such as an image slide show 310, a tapable section 312 that activates additional content, and an interactive segment exit button 314. Additional interactive features are also possible, such as video, scrollable text, user input boxes, etc.

Additionally, while the interactive segment 314 is presented through the visual stream of the media channel, a next media item can be concurrently presented through the audio stream. A user can interact with the different features of the interactive segment 308 during playback of the audio element of the currently playing media item. Once the interactive segment 314 terminates, such as through a user taping the exit button 314, the visual element corresponding to the currently playing media item can be presented on the display of the client device through the visual stream of the media channel.

A downside to simultaneously presenting both invitational content and media items when the invitational content is not related to the media items is that a user may equate the items. For example, a user may think that an invitational content provider endorses a particular media item, or that a media item provider has authorized the use of the media item to promote an offering within the invitational content package. This is particularly true when the user did not assemble the collection of media items presented within the media channel. To decrease the potential for confusion, the present technology can also include bumper content, which can be presented concurrently with the interactive invitational content, but just prior to resuming playback of a media item.

A bumper content item can be an intermediary content item that is used to transition from invitational content to a media item thereby creating user awareness that the media item is not related to an invitational content package that the user may also be experiencing. For example, a bumper content item can be used to transition between invitational content audio to media item audio, such as audio that says, “now back to the music.”

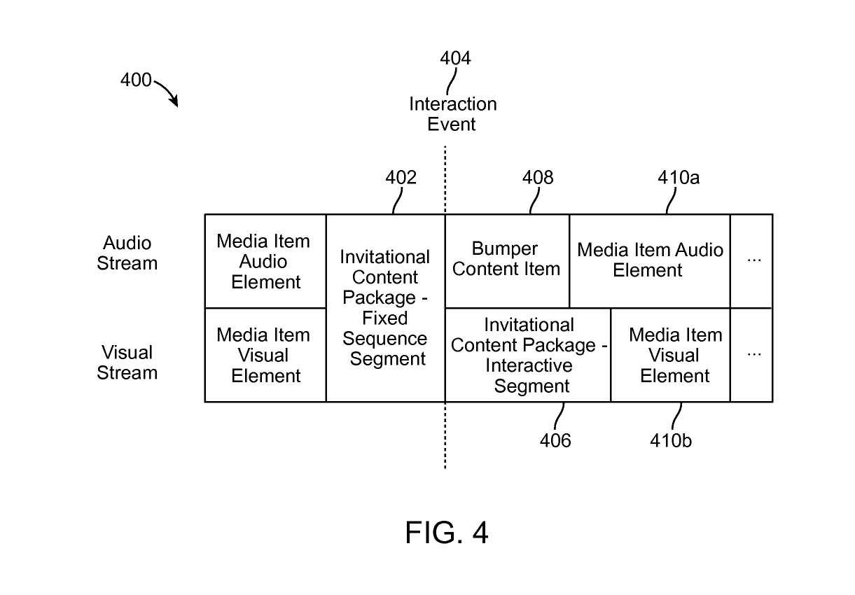

FIG. 4 illustrates an exemplary media channel playback scenario 400 that uses bumper content. As previously described, the media channel can be split into multiple streams, such as an audio and a visual stream. Each media item can also be configured to include multiple elements corresponding to the multiple streams, such as an audio and a visual element that are presented within the media channel through the respective streams. At some point during playback of the media channel, an invitational content package can be presented, such as invitational content package 402. The invitational content package can be configured to initially present a fixed sequence segment that occupies both the audio and visual streams, thereby preventing playback of a next media item.

In response to an interaction event, such as interaction event 404, the fixed sequence segment can be terminated and an interactive segment can be presented through one of the media channel streams, such as the interactive segment 406 that is presented through the visual stream. Instead of immediately beginning playback of an element of a next media item within the empty stream, a bumper content item can be presented. For example, bumper content item 408 can be presented in the audio stream. The bumper content item 408 can be a short, intermediary audio segment that transitions from any audio associated with the fixed sequence segment 402 and an audio element 410a of a next media item. For example, the bumper content can be audio that says: “now back to the music” or “now returning to the media provided by sponsor A.” The bumper content can be any content that signals to the user that the element of the media that is about to be presented is distinct from the content of the interactive segment that will be presented simultaneously with the media item. Upon completion of playback of the bumper content item 408, the audio element 410a of the next media item can be presented within the audio stream of the media channel. Once the interactive segment 406 terminates, such as through a user taping an exit button or passage of a specified time interval, the visual element of the media item whose audio element is currently playing can be presented within the visual stream, such as media item visual element 410b.

In some cases, an interactive segment can include both visual and audio content, such as an introductory audio clip presented in conjunction with visual elements or a video segment. In such a configuration, the interactive segment can prevent playback of a media item until a stream of the media channel is clear. For example, an interactive segment may be predominately visual with an introductory audio clip. In this case, the interactive segment audio element may complete playback before the interactive segment visual element terminates. This can create an empty audio stream that can be used to play an audio element of a next media item while the interactive segment visual component is still playing.

As with the previous scenarios, beginning playback of an element of a next media item while still presenting an element of an interactive segment can lead to an undesired association between the media item and the content of interactive segment. To decrease the likelihood of confusion, a bumper content item can be presented between the interactive segment element and the media item segment. For example, a bumper content item can be presented in the audio stream upon completion of an interactive segment audio element, and just prior to an audio element of a next media item.

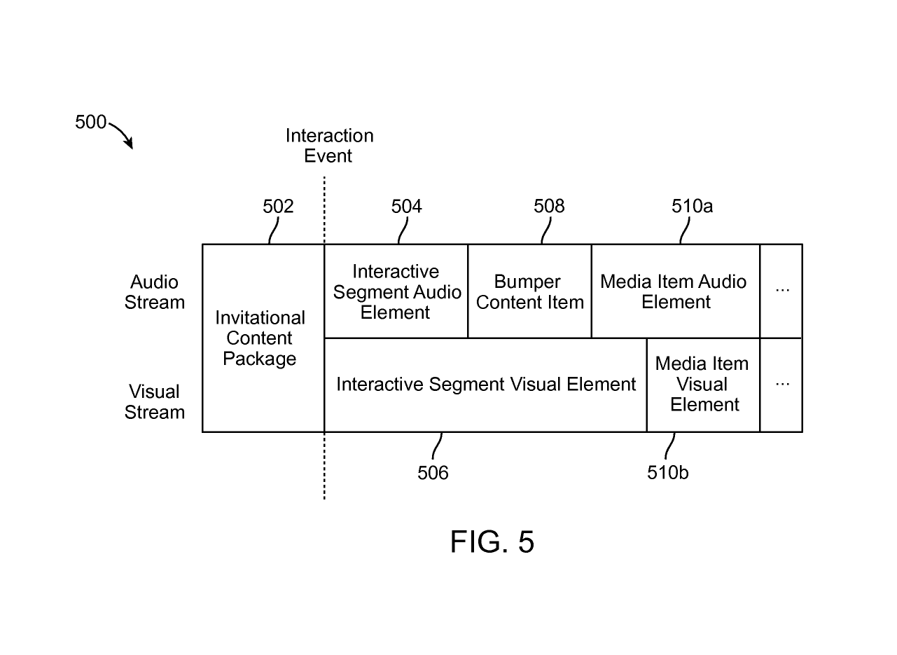

FIG. 5 illustrates an exemplary media channel playback scenario 500 in which the interactive content includes an audio element. At some point during playback of a media channel, an invitational content package can be presented, such as invitational content package 502. The invitational content package can be configured to include both an audio and a visual element. The invitational content package can be presented in a manner that prevents playback of a next media item.

In response to an interaction event 504 associated with the invitational content package 502, the invitational content package 502 can be immediately terminated, even if its playback duration has not expired, and an invitational content package interactive segment can be presented within the media channel. The interactive segment can include both an audio element 504 and a visual element 506, which can be presented within the respective streams of the media channel. In the media channel scenario 500, the audio element 504 is shorter than the visual element 506, which may be variable, even indefinite in length. Therefore, unless the user prematurely terminates the interactive segment, the audio element 504 will complete playback and leave an empty audio stream. The empty stream can be used to play back an audio element of a next media item.

Instead of immediately beginning playback of an element of a next media item within the empty stream, a bumper content item can be presented. Upon completion of playback of the bumper content item 508, the audio element 510a of the next media item can be presented within the audio stream of the media channel. Once the interactive segment visual element 506 terminates, such as through a user taping an exit button or expiration of a specified time interval, the visual element corresponding to the currently playing audio element can be presented within the visual stream, such as media item visual element 510b.

In some cases, user interaction with a currently presented interactive segment can activate a feature of the interactive segment that requires use of the second stream. For example, the interactive segment can be visual and can include a video with audio. When the user activates playback of the video, the interactive segment will require use of the audio stream in addition to the visual stream. Media channel playback can be configured so that when a user activates a feature of an interactive segment that requires use of an additional stream in the media channel the use can preempt playback of a currently playing media item element. For example, playback of the video with audio can temporarily pause playback of a media item audio element currently playing.

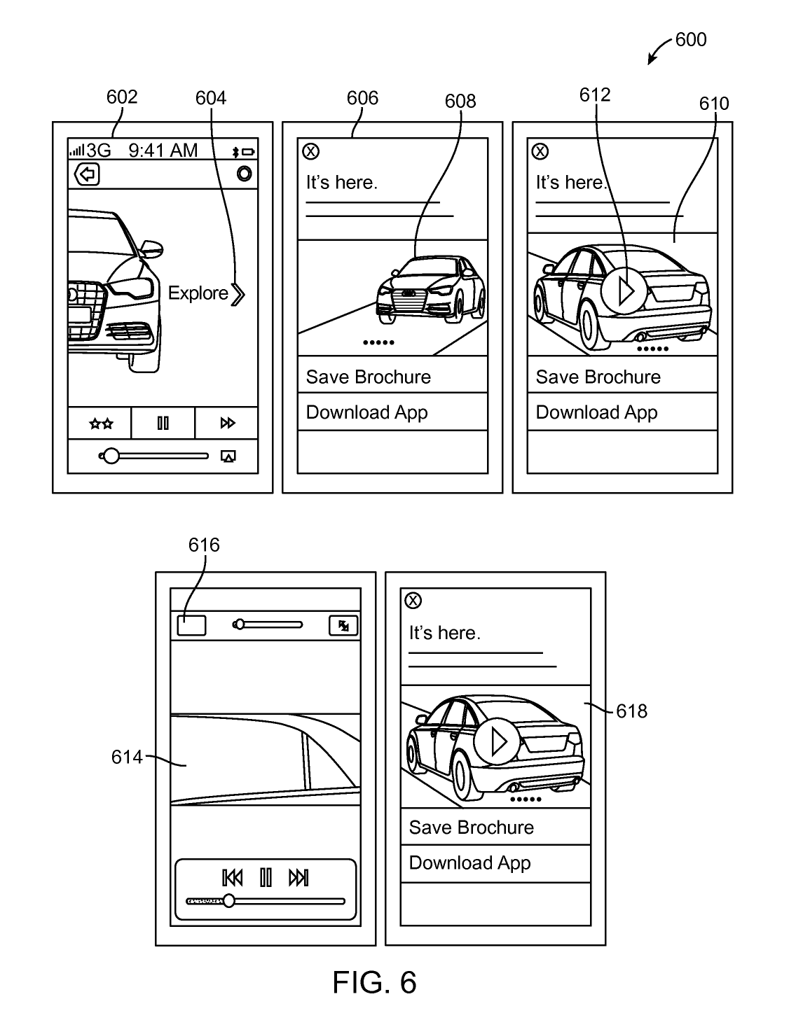

For example, FIG. 6 illustrates an exemplary media channel playback scenario 600 on a client device in which an interactive segment audio component can be triggered by user interaction. The invitational content package can include an audio and visual element and can be presented in a manner that prevents playback of a next media item. The audio element can be presented through an audio output device on the client device, such as a speaker, headphones, etc. The visual element can be presented on the display of the client device. In some cases, the invitational content package can be configured to initially present a fixed sequence segment, such as fixed sequence segment 602. The fixed sequence segment can be associated with an interactive segment triggering event, such as a tap, a click, a predefined movement of the client device, an audio command, etc. For example, fixed sequence segment 602 is associated with a tap interactive triggering event, which can be activated by receiving a tap by the client device in area 604.

In response to detecting the tap on area 604, the fixed sequence segment 602 can be replaced within the media channel with an interactive segment 606. The interactive segment 606 can be presented on the display of the client device via the visual stream of the media channel. The interactive segment 606 can include one or more interactive features and one or more element triggering events, such as an audio element triggering event and/or a visual element triggering event. An element triggering event can include a tap, a click, a predefined movement of the client device, an audio command, etc. The occurrence of an element triggering event can activate a second stream of an interactive segment. For example, if a visual stream of an interactive segment is initially displayed, the occurrence of an element triggering event can activate an audio stream of the interactive segment.

The interactive segment 606 can include a number of interactive features, such as the image slide show 608. The user can swipe through the images. In some cases, an image can be a video that includes audio, such as video item 610 in the interactive segment. The video item 610 can be associated with an element triggering event via the play button. When the user clicks on the video play button 612, an audio element triggering event can occur. The audio element triggering event can indicate that the interactive segment will require use of both the audio and visual streams of the media channel. The playback of the video from the interactive segment can preempt any currently playing media item audio element, as well as the interactive segment visual element. The preemption can automatically pause playback of the media item audio element and the interactive segment visual element. Upon completion of the video, either through user-initiated termination, e.g. by clicking button 616, or by completing playback, the audio stream can be freed from use by the interactive segment. This can allow the media channel to resume playback of the paused media item audio element within the audio stream. However, in some cases, prior to resuming playback of the paused media item audio element, a bumper content item can be played to create a transition between the invitational content and the media item. Additionally, the media channel can resume playback of the interactive segment visual element. In some cases, the interactive segment visual element can be presented as it was prior to the video. For example, the video can be replaced in the visual segment with the interactive segment 618.

In some embodiments, rather than immediately preempting the currently playing audio, when the client device detects a tap of play button 612, the audio volume can decrease and be automatically mixed or faded into the playback of video 610 such that the audio associated with video 614 will gradually replace the previously playing audio.

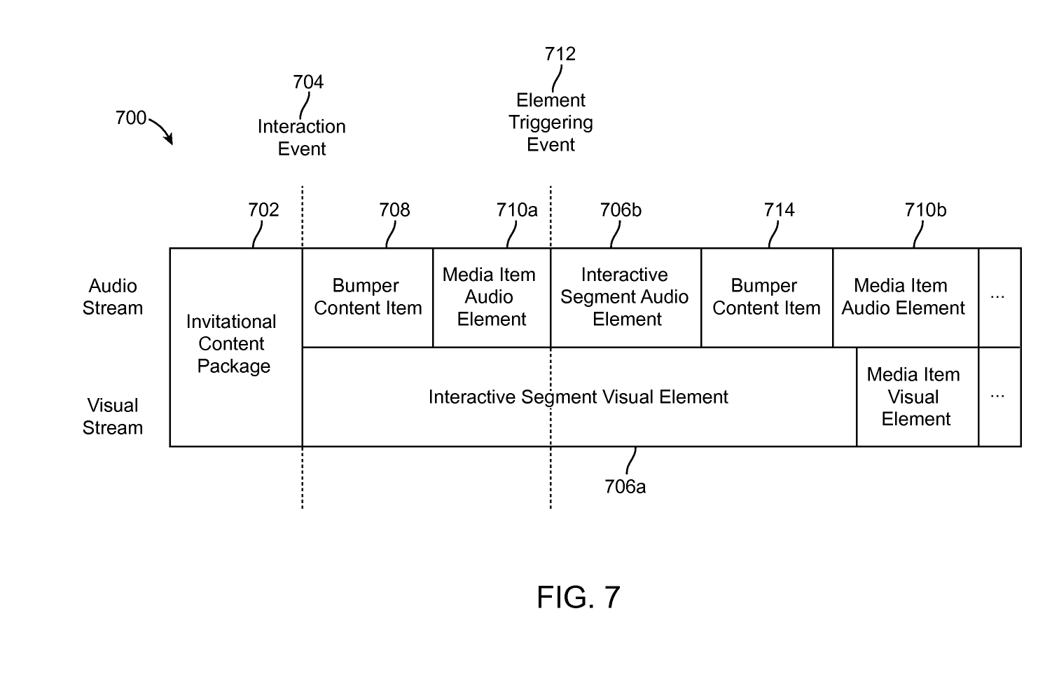

FIG. 7 illustrates an exemplary media channel playback scenario 700 detailing the audio and visual streams when a user triggers an interactive segment audio element. At some point during playback of a media channel, an invitational content package can be presented, such as invitational content package 702. The invitational content package can be configured to include both an audio and a visual element. The invitational content package can be presented in a manner that prevents playback of a next media item.

In response to an interaction event 704 corresponding to an interactive segment triggering event associated with the invitational content package 702, an invitational content package interactive segment can be presented within the media channel. The interactive segment can include both an audio element 706b and a visual element 706a. However, in this case, the audio element 706b is not immediately active. For example, the interactive segment audio element can be activated by user interaction or can become active after a predefined period of time. Therefore, initially, the interactive visual segment 706a can be presented within the visual stream of the media channel.

Instead of immediately beginning playback of an element of a next media item within the empty audio stream, a bumper content item can be presented. For example, bumper content item 708 can be presented in the audio stream. Upon completion of playback of the bumper content item 708, the audio element 710a of the next media item can be presented within the audio stream of the media channel.

At some point during playback of the interactive segment visual element 706, an element triggering event can occur, such as audio element triggering event 712. The audio element triggering event 712 can activate the interactive segment audio element 706a. For example, the interactive segment can include a video with audio that a user can play. In this example, the element triggering event can be the user clicking on a play button. When this occurs, the interactive segment requires use of the audio stream of the media channel. To accommodate the need for the audio stream, the media channel can temporarily pause playback of the media item audio element 710a and can begin playback of the interactive segment audio element 706b.

Upon completion of the interactive segment audio element 706b, the audio stream is again empty. Therefore, the media channel can resume playback of the media item audio element. However, instead of immediately resuming playback of the media item audio element, the media channel can playback a bumper content item 714 within the audio stream. Upon completion of the bumper content item 714, the media channel can resume playback of the media item with audio element 710b.

In some cases, a single bumper content item can be used anytime a bumper content item is required, regardless of media station. However, in some configurations, bumper content can be customized. For example, a bumper content item can be media station specific, such as “and now back to media station A.” In another example, a bumper content item can be specific to a next media item that is scheduled for playback, such as “and now playing song A.” A bumper content item can also be customized based on a number of other factors, such as user characteristics, the current invitational content, a previously played media item, a sponsor of a media channel, etc.

The selection and/or display of the bumper content on a media station can be based on one or more rules or constraints. A type of rule can be a bumper content playlist generation rule. A bumper content playlist generation rule can define which items of bumper content are candidates for playback on a particular media station. A bumper content playlist generation rule can explicitly define which bumper content items can be played on a particular station. For example, a sponsor of a media station may define a bumper content playlist generation rule that specifies particular bumper content items that can be played on the sponsored station. A bumper content playlist generation rule can also be defined based on user characteristics or demographic information. For example, a bumper content playlist generation rule can specify the user characteristic values of female and 35-40 years old. Using this bumper content playlist generation rule, bumper content items can be selected that are determined to match the user characteristic values. In some cases, this determination can be based on metadata associated with the bumper content items. Additionally, a bumper content playlist generation rule can be defined based on one or more general constraints, such as genre, media type, presentation type, bandwidth requirements, processor requirements, client device type, etc. Furthermore, a bumper content playlist generation rule can be defined in terms of a seed item. A bumper content playlist generation rule based on a seed item can also include a measure of similarity. By applying a seed based bumper content playlist generation rule, bumper content items determined to be sufficiently similar to the seed item can be selected as candidates for playback on the media station. In some cases, a seed item can be another bumper content item, a media item, and/or an invitational content package.

A bumper content playlist generation rule can also be defined based on matching metadata. For example, a media station can have associated metadata that describes the media station and each item of bumper content can have associated metadata describing the item of bumper content. Items of bumper content with sufficiently matching metadata, as defined by the rule, can be selected as candidate bumper content.

In some cases, a bumper content playlist generation rule can be station specific. For example, a bumper content playlist generation rule can specify a presentation type or genre for a media station. However, a bumper content playlist generation rule can also be station independent. For example, a bumper content playlist generation rule can specify one or more user characteristics, such as user characteristics associated with a user of a client device playing the media station. In some cases, such a bumper content playlist generation rule can be applied in conjunction with one or more other station specific bumper content generation rules, such as station specific rules, to generate a media station that is further customized to a particular end-user requesting the media station. In some cases, the selection of candidate bumper content for a media station can be based on the application of more than one bumper content playlist generation rule.

Another type of rule can be a bumper content playback rule. A bumper content playback rule can define constraints on the playback order of any bumper content and/or whether a bumper content item should be played at all. In some cases, a bumper content playback rule can be based on matching metadata. For example, a bumper content playback rule can be defined to identify a bumper content item with sufficiently matching metadata to a just completed media item, a next to play media item, or a currently playing invitational content package. A bumper content playback rule can also be time based. For example, a bumper content playback rule can specify a minimum time between the playback of a first item of bumper content and a second item of bumper content. Therefore, if a second item of bumper content is requested for the media station and the minimum time interval has not yet been reached, the request can be denied and a second item of bumper content will not be presented at that time. This situation can occur if the interactive segment of the invitational content package includes multiple features that could disrupt playback of a media item. For example, if the interactive segment includes multiple videos with audio. A user may watch one video and shortly after resuming playback of a media item, the user selects another video. By playing bumper content a second time, the user experience can degrade. Additionally, since the user previously heard the bumper content associated with the media, the user may not need to hear it again to know that the media item and invitational content are distinct. A bumper content playback rule can also be media item based. For example, a bumper content playback rule can specify a maximum number of bumper content items that can be played during the playback of a single media item. Furthermore, a bumper content playback rule can be media station sponsor defined. For example, a sponsor of a sponsored station can specify one or more constraints regarding what bumper content can be presented, how it can be presented, and/or when it can be presented. A bumper content playback rule can also be trigger based. For example, a bumper content playback rule can specify a first classification of bumper content when playback will resume with a new media item, and a second classification of bumper content when playback will resume a previously paused media item.

To apply some bumper content playback rules, media item playback historical data, invitational content playback historical data, and/or bumper content playback history data may be required. For example, a bumper content playback rule based on previously played bumper content can require playback historical data. In some cases, playback historical data can be maintained for only as long is required to ensure that one or more bumper content playback rules are satisfied. For example, for a time based bumper content playback rule, playback historical data can be maintained for only as long as the longest time period, such as one-hour.

In some cases, a bumper content playback rule can be station specific. For example, a bumper content playback rule can apply exclusively to a media station associated with a sponsorship agreement. Therefore, any playback historical data that is only necessary to enforce the station specific bumper content playback rule can be reset upon a switch from a first media station to a second media station. For example, bumper content playback historical data used by a sponsor defined bumper content playback rule, which limits playback of bumper content items from a competitor during a specified time interval, can be reset upon a switch in media stations. However, a bumper content playback rule can also be station independent, and therefore the corresponding playback historical data can also be station independent. For example, a rule based on an overall time period between presentation of a first and second bumper content items can be applicable across media stations.

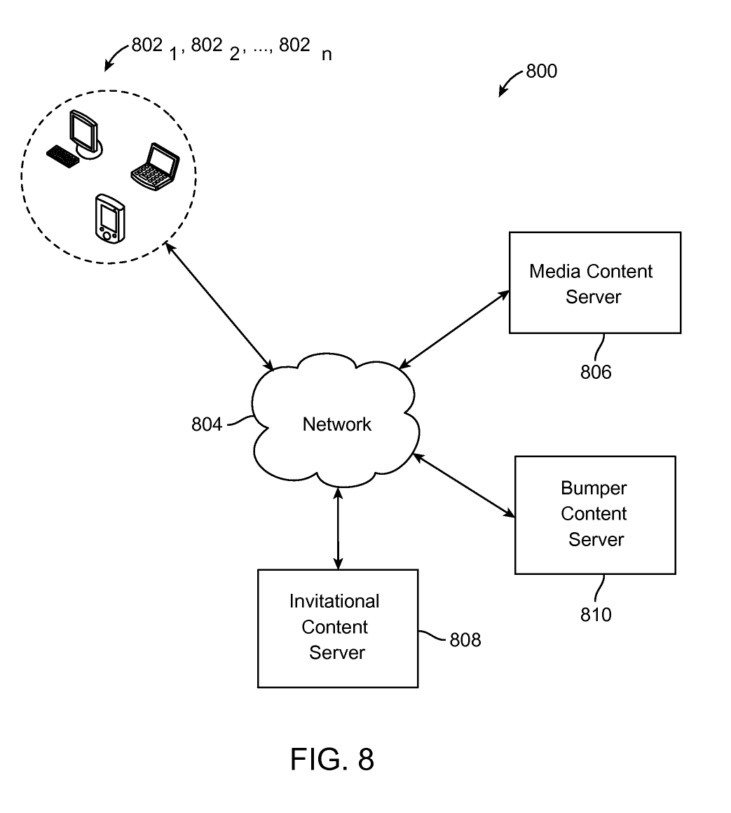

An exemplary system configuration 800 for presenting interactive invitational content within a media station is illustrated in FIG. 8 wherein electronic devices communicate via a network for purposes of exchanging content and other data. The system can be configured for use on a local area network, such as that illustrated in FIG. 8. However, the present principles are applicable to a wide variety of network configurations that facilitate the intercommunication of electronic devices. For example, each of the components of system 800 in FIG. 8 can be implemented in a localized or distributed fashion in a network.

In system 800, media items, invitational content packages, and/or bumper content can be delivered to client devices 802₁, 802₂, . . . , 802ₙ (collectively “802”) connected to a network 804 by direct and/or indirect communications with a media content server 806, an invitational content server 808, and/or a bumper content server 810. A client device 802 can be any network enabled computing device capable of receiving content for playback within a media channel such as a desktop computer; a mobile computer; a handheld communications device, e.g. mobile phone, smart phone, tablet; a smart television; a set-top box; and/or any other network-enabled computing device. Furthermore, the media content server 806, invitational content server 808, and/or bumper content server 810 can concurrently accept connections from and interact with multiple client devices 802.

Although the media content server 806, the invitational content server 808, and the bumper content server 810 are presented herein as separate entities, this is for illustrative purposes only. In some configurations, the media content server 806, invitational content server 808, and/or bumper content server 810 can be the same entity. Thus, a single entity can provide the media items, the invitational content items, and/or the bumper content items. Additionally, the system 800 can be configured with multiple media content servers, invitational content servers, and/or bumper content servers. For example, the system 800 can include bumper content servers for different types of bumper content items, e.g. music, video, television shows, etc. Furthermore, in some configurations, a content distribution network can act as an intermediary between client devices 802 and one or more content servers.

In some configurations, a client device can request a media item, an invitational content package, and/or a bumper content item from a content server at the time that a content item is needed for playback. In this configuration, the content server can apply one or more content playlist rules and/or one or more content playback rules to identify a content item for the client device. However, such a configuration creates a heavy burden on the client device and can have performance issues when used in situations with less reliable or inconsistent Internet connections. To mitigate these disadvantages, one or more content items and one or more content playback rules can be cached on the client device. The caching makes it possible to shift to the client device at least a portion of the decision-making regarding which content to present and when. When needed, the client device can apply one or more content playback rules to identify a content item to add to the content stream of a media station. In particular, the present technology can cache a list of one or more bumper content items and one or more bumper playback rules on a client device 802.

In some cases, the bumper content server 810 can receive a request for a list of one or more bumper content items, from one of client devices 802. The request can be specific to a media station and thus, as part of the request, a client device 802 can specify a station identifier. The bumper content server 810 can use the station identifier to identify a previously defined media station. In some cases, a previously defined media station can be a curated station. That is, a station corresponding to a predefined collection of media items. For example, a curated station can be sponsored by a sporting goods company, and the sporting goods company can preselect a collection of media items that the sporting goods company has identified as exercise related media items, such as songs good for running. A previously defined media station can also be a user specific media station, such as a media station based on user characteristic values known about the user. Additionally, a previously defined media station can be a media station based on a seed item, such as a media item or artist. Additional methods of defining a media station are also possible.

In some cases, a media station can be defined just prior to initiating a media station. For example, a user can select a media item and then select a play station button. Upon clicking the button, a new station can be created and a station identifier can be assigned to the station. In some configurations, the media content server 806 can assign the station identifier and distribute the station identifier to the client device 802, the invitational content server 808, and/or the bumper content server 810. Additionally, metadata associated with the station can be distributed. Alternatively, the system 800 can include an independent media station generation server, which can be responsible for establishing new stations, and distributing the pertinent information, such as station identifier, station metadata, and/or station specific rules to the relevant parties. A previously defined media station can also be an established media station, such as a curated or sponsored station, or a station based on a genre or a media item producer. In this case, upon selecting a play station button, the station identifier can be obtained.

In response to receiving the request for a list of candidate bumper content items, the bumper content server 810 can select one or more bumper content items and send the list to the requesting client device 802. Each candidate bumper content item can be associated with metadata that describes the bumper content item. The number of items specified in the list of candidate bumper content items can vary with the configuration of the system, the rules associated with the station, the client device type, the bandwidth available, the media item type, and/or user preference. For example, the system 800 can be configured with a single bumper content item or a single bumper content item per station. In another example, the system 800 can be configured to default to a specific number of items or a number of items based on total playback time. The number of items can then be adjusted up or down based on the storage capacity of the requesting device. The number of items can also be adjusted based on the current network connection. For example, the number of items could be increased when connected over a broadband connection and decreased when connected over a cellular connection. Additionally, a user could specify a maximum allowable storage space on the client device or a user could request additional caching when the user knows network connectivity will be lost, such as when boarding a plane.

In some cases, the client device 802 can request the list of candidate bumper content items from the bumper content server 810 in response to an initial generation of a media station. For example, when starting a media station player or when switching from a first media station to a second media station. Additionally, the client device 802 can request a list of candidate bumper content items when a number of bumper content items remaining in the cached list of candidate bumper content items falls below a predefined threshold value. For example, the initial list of candidate bumper content items may include ten bumper content items, with a minimum size threshold of five unused bumper content items. In some configurations, a bumper content item specified in the list of candidate bumper content items can be considered used when it has been evaluated for playback eligibility. However, in other configurations, a bumper content item can be considered used only when it has been deemed eligible for playback. Therefore, any bumper content item evaluated to be currently ineligible at a time of testing could be retried at a later time. In some cases, a bumper content item can be discarded from the list of candidate bumper content items after evaluating the item for eligibility a predefined number of times. Once the predefined threshold has been reached additional candidate bumper content items can be added to the list to replace the used bumper content items. In some cases, the predefined threshold can vary with the configuration of the system, the client device type, the available bandwidth, the bumper content item type, and/or user preference. For example, in some cases, a bumper content item may not have an associate maximum number of playbacks.

The client device 802 can also be configured to request an update after a specified period of time. For example, if a media stream has been paused for a significant period, upon playback resumption the client device can request an update or refresh. In another example, if the client device has been disconnected from the network for a predefined period of time, upon reconnecting the client device can request an update or refresh. In some cases, the refresh rate can be based on a prediction as to when new content will be needed by analyzing the user's usage history. The usage history can include a history of station identifiers, and therefore the client device 802 could predict when a user will change stations and/or what stations the user may play and content appropriate for the predicted station identifiers can be refreshed.

In addition to the list of candidate bumper content items, the bumper content server 810 can send one or more bumper content playback rules. In some cases, one or more bumper content playback rules sent to the client device 802 can be station specific, such as rules established by a station sponsor. Additionally, one or more rules sent to the client device 802 can be station independent, such as rules based on minimum time between bumper content playbacks. The rules can be cached on the client device 802 and used by the client device 802 to identify a next bumper content item eligible for playback from the list of candidate bumper content items. Further details regarding how a client device uses the one or more bumper content playback rules will be discussed below.

How often and/or with which requests the bumper content server 810 sends one or more bumper content playback rules can vary with the configuration and/or the bumper content playback rules already cached on a client device 802. In some cases, a bumper content server 810 can send all relevant bumper content playback rules regardless of whether or not a client device 802 already contains a rule. Alternatively, the bumper content server 810 can be configured to only send the bumper content playback rules that the client device 802 is missing or that are expired. In some cases, a bumper content server 810 can send the full set of bumper content playback rules relevant to the station upon station initiation and then provide necessary updates when a client device requests an update to the list of candidate bumper content items or when a client device 802 specifically requests an update to the bumper content playback rules, such as at periodic intervals.

Additionally, the bumper content server 810 can be configured to push new or updated bumper content playback rules to a client device 802. For example, when a sponsorship agreement changes, one or more bumper content playback rules may also change. In this case, the change may require the new playback rules to be distributed to a client device even though the client device has not requested an update.

In some embodiments, client device 802 can send additional information, such as a user identifier, to the bumper content server 810. The additional information can be sent as part of a request for content from the bumper content server 810 or in a separate communication with the bumper content server 810. In some cases, the user identifier can be specific to the bumper content server 810. For example, the bumper content server 810 can maintain a user profile and the bumper content server 810 can use the user profile in selecting the bumper content items for the list of candidate bumper content items. For example, the bumper content server 810 can use the user profile information in conjunction with a bumper content playlist generation rule that is based on user characteristics or demographic data to better customize the list of candidate bumper content items for the user.

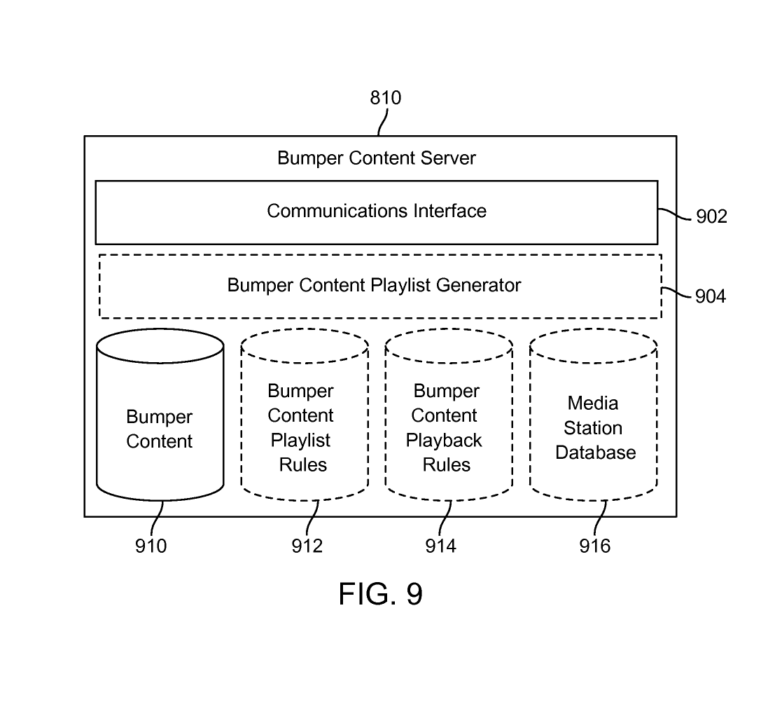

FIG. 9 illustrates an exemplary configuration of a bumper content server 810. The bumper content server 810 can contain a number of components. The components can include one or more databases for storing data relevant to the operation of the system, e.g. a bumper content database 910, a bumper content playlist rules database 912, a bumper playback rules database 914, and/or a media station database 916, and one or more modules for interacting with the databases and/or controlling the features provided by the bumper content server 810, e.g. a communications interface 902 and a bumper content playlist generator 904. Each of the components in FIG. 9 is discussed in more detail below; however, it should be understood by one skilled in the art, that the architectural configuration illustrated in FIG. 9 is simply one possible configuration and that other configurations with more or less components is also possible. For example, a system configured to serve bumper content on demand, may also include a bumper content playback module.

The bumper content server 810 can maintain a number of assets and/or data, such as the one or more databases of information. In the exemplary configuration in FIG. 9, the bumper content server 810 maintains four databases. However, it should be understood by one skilled in the art that the bumper content server 810 can be configured with more or less databases. For example, the bumper content server 810 can be configured with multiple bumper content databases, such as separate databases for different bumper content item types, or separate databases for station specific bumper content and station independent rules.

The bumper content server 810 can include bumper content items. The bumper content database 910 can be populated with the various bumper content items. Additionally, each bumper content item in the bumper content database 910 can have associated metadata that can describe the bumper content item and a unique bumper content item identifier.

The bumper content server 810 can also include one or more bumper content playlist generation rules for identifying candidate bumper content items for a media station. The bumper content playlist generation rules database 912 can be populated with various bumper content playlist generation rules. In some cases, a bumper content playlist generation rule can be specific to one or more bumper content stations. Such bumper content playlist generation rules can be associated with the one or more media station identifiers in the bumper content playlist rules database 912. The bumper content playlist generation rules can be expressed using a variety of formats and/or file types. For example, a bumper content playlist generation rule can be expressed using XML, or some other mark-up language. In another example, a bumper content playlist generation rule can be expressed using computer executable instructions, such as javascript.

The bumper content server 810 can also include one or more bumper content playback rules that can be used to determine whether a candidate bumper content item is currently eligible for playback. The bumper content playback rules database 914 can be populated with the various bumper content playback rules. In some cases, a bumper content playback rule can be specific to one or more media stations. Such bumper content playback rules can be associated with the one or more media station identifiers in the bumper content playback rules database 914. The bumper content playback rules can be expressed using a variety of formats and/or file types. For example, a bumper content playback rule can be expressed using XML, or some other mark-up language. In another example, a bumper content playback rule can be expressed using computer executable instructions, such as javascript.

The bumper content server 810 can also include information regarding one or more previously defined media stations. The media station database 916 can be populated with the media station information. Each media station can be assigned a unique station identifier, which can be stored in the media station database 916. Additionally, each media station in the media station database 916 can have associated metadata that can describe the media station.

In some configurations, the bumper content server 810 can include additional databases, such as a user profile or user account database. A user profile database can include user characteristic data known about the user such as user identifier, demographic information, etc. The user profile information can be used to aid in selecting candidate bumper content items for a media station.

The bumper content server 810 can include a communications interface 902. The communications interface 902 can be configured to receive requests from one or more client devices 802. The requests can include a request for a new or updated list of candidate bumper content items and/or a request for new or updated bumper content playback rules. The communications interface 902 can also be configured to send data to a requesting one or more client devices 802. The sent data can be a new or updated list of bumper content items, which can include the actual bumper content items and/or new or updated bumper content playback rules. Each bumper content item distributed to a client device can have associated metadata describing the bumper content item.

The bumper content server 810 can also include a bumper content playlist generator 904. The bumper content playlist generator 904 can be configured to generate a list of candidate bumper content items in response to a request from a client device 802. To generate a list of candidate bumper content items, the bumper content playlist generator 904 can apply one or more bumper content playlist rules to the available bumper content items. The one or more bumper content playlist rules applied can be based on the station. For example, all bumper content playlist generation rules associated with the media station identifier can be applied, as well as any media station independent rules, unless the station definition excludes media station independent rules.

The client device 802 in FIG. 8 can receive the requested data, which can include media items, invitational content items, bumper content items, and/or one or more content playback rules, including one or more bumper content playback rules. The client device 802 can use the received data to add content to a content stream for the media station.

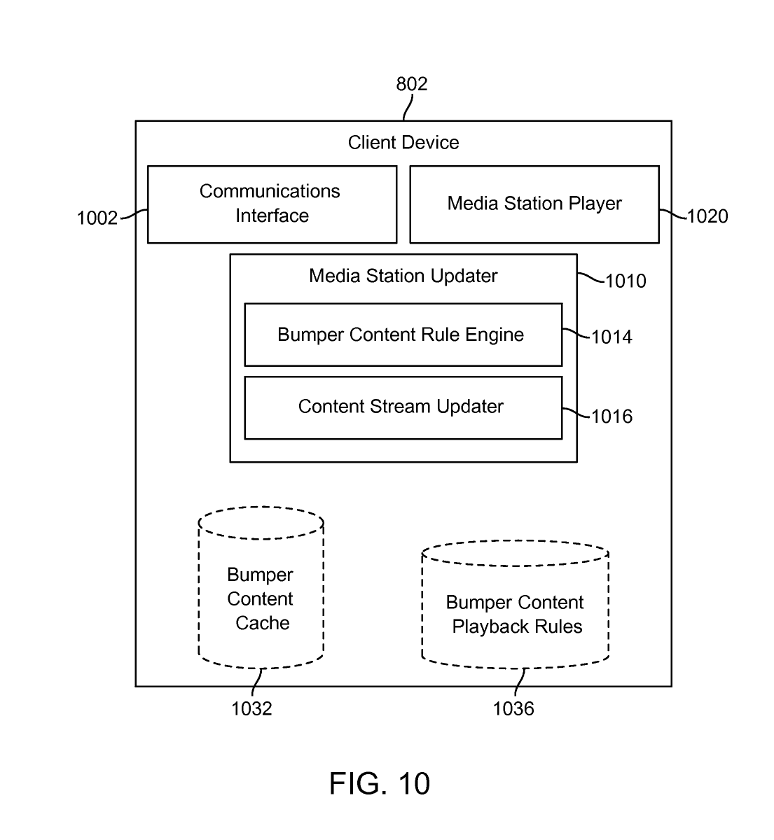

FIG. 10 illustrates an exemplary configuration of a client device 802. The client device 802 can include a number of components to aid in adding content to the media station. The components can include one or more databases or other storage structures for storing data relevant to the operation of the system, e.g. bumper content cache 1032 and bumper content playback rules database 1036, and one or more modules for interacting with the storage structures and/or controlling the features provided by the client device 802, e.g. communications interface 1002, media station player 1020, media station updater 1010, bumper rule engine 1014, and content stream updater 1016. Each of the components in FIG. 10 is discussed in more detail below; however, it should be understood by one skilled in the art, that the architectural configuration illustrated in FIG. 10 is simply one possible configuration and that other configurations with more or less components are also possible. For example, the client device 802 can also include storage structures for media items and/or invitational content packages and modules for interacting with the storage structures, e.g. media item rule engine and/or invitational content package rule engine.

The client device 802 can maintain a number of assets and/or data, such as the one or more storage structures of information. In the exemplary configuration in FIG. 10, the client device 802 maintains two storage structures. However, it should be understood by one skilled in the art that the client device 802 can be configured with more or less storage structures. The client device 802 can receive a list of candidate bumper content items from which the client device 802 can select currently eligible bumper content items for playback on the media station. The client device 802 can store the list of candidate bumper content items in the bumper content cache 1032. The list of candidate bumper content items can include a unique bumper content item identifier, a bumper content item, and/or associated metadata for each bumper content item in the list.

When and what data is erased from the bumper content cache 1032 can vary with the configuration of the system and/or the type of bumper content. The system can be configured to support multiple classes of bumper content. A class of bumper content can be one or limited use bumper content. That is, an item of bumper content can have an associated maximum use count. Once the item of bumper content has been played the maximum number of times it can be designated unusable. Another class of bumper content can be time based. That is, an item of bumper content can have an associated expiration value, such as a date or time period. Once the expiration value has been reached, the bumper content item can be designated unusable.

In some configurations, a bumper content item can be removed from the bumper content cache 1032 after playback has completed or once a bumper content item has been determined to be unusable. As described above, the client device 802 can be configured to check the eligibility of a bumper content item in the list of candidate bumper content items one or more times prior to designating the bumper content item as unusable. However, in some cases, once a bumper content item has been designated unusable, the bumper content item can be removed from the bumper content cache 1032. In some configurations, all downloaded bumper content items can remain in the bumper content cache 1032 until the client device 802 receives a new list of candidate bumper content items. Additionally, the termination of a bumper content station can cause the client device 802 to erase the cached bumper content items and/or the list of candidate bumper content items. In some cases, the client device 802 can be configured to remove data from the bumper content cache 1032 after a predefined period of inactivity or upon expiration of the bumper content item.

The invitational content cache 1032 can also be configured to cache data relevant to multiple media stations. In this configuration, when switching from a first media station to a second media station, the client device 802 can maintain the cached data from the first media station. This can be advantageous in that it can allow a user to switch between media stations without requiring a refresh of the content. In some cases, a maximum number of media stations can be set. Once the maximum has been reached the client device 802 can remove data associated with a media station, such as the media station that has not been used for the longest period of time. Additionally, the client device 802 can be configured to remove data associated with a media station after a predefined period of inactivity.

The client device 802 can also receive one or more bumper content playback rules, which can be stored in the bumper content playback rules database 1036. The client device 802 can use the various rules to determine which bumper content items to play on the media station. In some cases, a playback rule can be specific to one or more media stations. Such playback rules can be associated with the one or more media station identifiers in the rules databases.

In some cases, a rules database can be configured to maintain playback rules for a single media station. In this case, upon switching to a new media station, the playback rules can be replaced. Alternatively, a rules database can be configured to maintain playback rules for multiple media stations. In this case, playback rules can be removed and/or updated as needed. For example, if there is insufficient space to store the rules for a currently active media station, the rules associated with an old media station can be replaced. In another example, if a playback rule has been updated, such as a rule based on a licensing agreement, the playback rule in a rules database can be updated.

The client device 802 can include a communications interface 1002. The communications interface 1002 can be configured to send requests to the media content server 806, the invitational content server 808, and/or the bumper content server 810. The requests can include a request for a new or updated list of candidate content items, including bumper content items. The communications interface 1002 can also be configured to receive data from the media content server 806, the invitational content server 808, and/or the bumper content server 810. The received data can include one or more content items and/or one or more content playback rules.

The client device 802 can also include a media station updater 1010. The media station updater 1010 can include one or more modules, e.g. a bumper content rule engine 1012 and a content stream updater 1016, for processing the list of candidate bumper content items to add to the content stream for the media station.

The bumper content rule engine 1014 can be configured to apply one or more bumper content playback rules from the bumper content rules database 1036 to the list of candidate bumper content items in the bumper content cache 1032 to identify bumper content that is currently eligible for playback. In some cases, the bumper content rule engine 1014 can identify more than one bumper content item that is currently eligible for playback. In the event that only a single bumper content item is required at the particular time, a best-fit bumper content item can be selected. For example, a playback rule associated with the station may indicate a bumper content item preference. In another example, metadata associated with the bumper content items and the media station and/or current media items can be matched.

If a bumper content item is eligible for playback, the bumper content item can be added to the appropriate content stream, e.g. audio or visual, for the media station. Furthermore, in some cases, the bumper content rule engine 1014 can mark the bumper content item as used or increment an associated use counter. In some cases, the bumper content rule engine 1014 can be configured to check a bumper content item multiple times for eligibility when previous checks returned ineligible. After a predetermined number of verifications, the bumper content rule engine 1014 can mark a bumper content item as unusable.

In some configurations, the bumper content rule engine 1014 can be activated in response to a bumper content triggering event or action. Bumper content triggering events can include detecting an interactive segment triggering event within an invitational content package fixed sequence segment and/or completion of an element of an interactive segment while the other element remains active, e.g. completion of an interactive segment audio element while the interactive visual segment remains playing. Additionally, the bumper content triggering action can be a factor in selecting a presentation method. For example, if the trigger is completion of an interactive segment audio element, the presentation method can be an audio bumper content item.

The content stream updater 1016 can be configured to communicate with the bumper content rule engine 1014 to identify next bumper content items to add to a content stream associated with the media stream.

Finally, the client device 802 can include a media station player 1020 that can playback the media items, invitational content packages, and the bumper content items added to the content stream. The media station player 1020 can fetch the next content item from the content stream when a next item is required for playback. The media station player 1020 can include functionality such as pausing, skipping, liking, banning, initiate new media station, etc.

In the various embodiments, the one or more databases described herein can be implemented using any type of data structures. Such data structures include but are not limited to, data structures for relational databases, key/value stores, graph databases, hierarchical databases, and distributed or columnar stores. According, although the various embodiments described herein may refer to specific data structures, in other embodiments such data structures can be substituted for any other data structures.

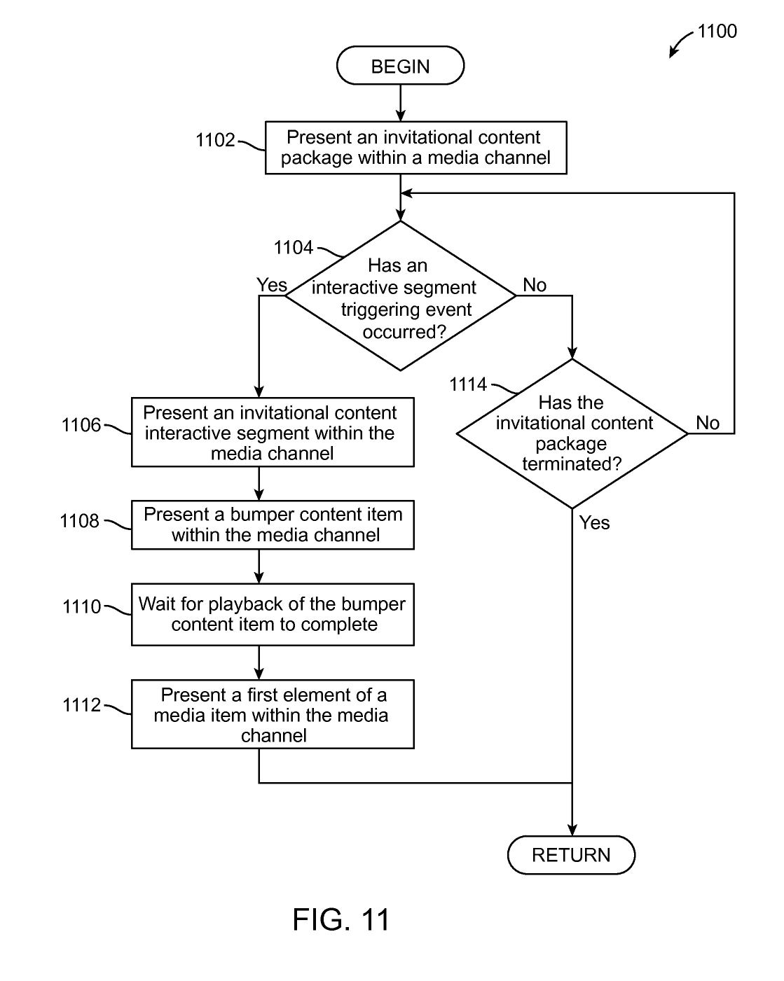

FIG. 11 is a flowchart illustrating steps in a first exemplary method 1100 for presenting interactive invitational content within a media channel. For the sake of clarity, this method is discussed in terms of an exemplary client device 802 in FIG. 10. Although specific steps are shown in FIG. 11, in other embodiments a method can have more or less steps.

At some point during playback of a media channel, the client device 802 can present an invitational content package within the media channel (1102). In some cases, the invitational content package can be configured such that a fixed sequence segment is initially presented within the media channel. Furthermore, the invitational content package can be presented in a manner that prevents playback of a next media item until the fixed sequence segment terminates.

After presenting the invitational content package, the client device 802 can wait for an interactive segment triggering event corresponding to the invitational content package to occur (1104). The interactive segment triggering element can be associated with one or more predefined interaction events, such as a tap, click, predefined movement, or audio command. When the interactive segment triggering event occurs, the client device 802 can simultaneously present an invitational content interactive segment within the media channel (1106) and a bumper content item (1108). As described above, in order to achieve concurrent presenting of the two items, the media channel can be split into multiple streams, such as an audio stream and a visual stream. Then an element, such as a visual element, of the interactive segment can be presented within one stream, and the bumper content can be presented within the other stream. Alternatively, an audio element of the interactive segment can be presented and the bumper content can be presented within the visual stream.

After presenting the bumper content item, the client device 802 can wait for the bumper content item to complete playback (1110). Once the bumper content item completes playback, the client device 802 can present an element of a next media item within the stream previously occupied by the bumper content (1112). For example, if the bumper content was audio content, upon completion of the bumper content, the audio stream will be empty. Therefore, the client device 802 can present an audio element of a next media item. The presentation of the element of the next media item can occur simultaneously with the interactive segment content. Once the interactive segment terminates, such as through a user taping an exit button or expiration of a specified time interval, a second element corresponding to the currently playing media can be presented within the stream previously occupied by the interactive segment. For example, if the interactive segment was playing in the visual stream, a visual element of the media item that corresponds to the currently playing audio element can be presented within the media channel. In some cases, the interactive segment can terminate prior to completing playback of the bumper content item. In this case, the client device 802 can be configured to complete playback of the bumper content item prior to presenting an element of a next media item.

In some cases, the invitational content package can terminate without the occurrence of an interactive segment triggering event (1114). For example, the invitational content package can terminate upon completion of a predefined period of time, completion of an audio or video segment, or a user initiated exit. In this case, the media channel can continue playback with a next media item, without presenting an interactive segment or a bumper content item. After presenting an element of a media item within the media channel or determining that the invitational content package has terminated, the client device 802 can resume previous processing, which can include repeating method 1100.

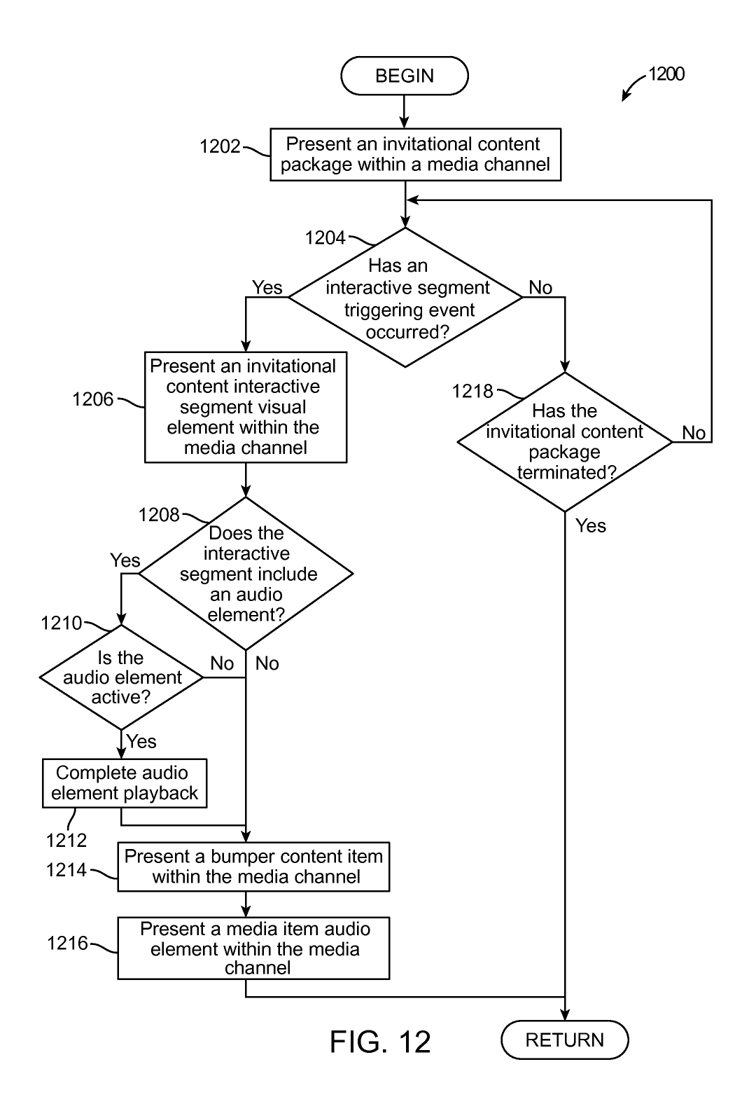

FIG. 12 is a flowchart illustrating steps in a second exemplary method 1200 for presenting an interactive invitational content item within a media channel. For the sake of clarity, this method is discussed in terms of an exemplary client device 802 in FIG. 10. Although specific steps are shown in FIG. 12, in other embodiments a method can have more or less steps than show.

At some point during playback of a media channel, the client device 802 can present an invitational content package within the media channel (1202). In some cases, the invitational content package can be configured such that a fixed sequence segment is initially presented with in the media channel. Furthermore, the invitational content package can be presented in a manner that prevents playback of a next media item until the fixed sequence segment terminates.

After presenting the invitational content package, the client device 802 can wait for an interactive segment triggering event corresponding to the invitational content package to occur (1204). The interactive segment triggering element can be associated with one or more predefined interaction events, such as a tap, click, predefined movement, or audio command. When the event occurs, the client device 802 can present an invitational content interactive segment visual element within the media channel (1206).

In some cases, an interactive segment can include both visual and audio content, such as an introductory audio clip presented in conjunction with visual elements or a video segment. In such a configuration, the interactive segment can prevent playback of a media item until a stream of the media channel is clear. Therefore, the client device 802 can check if the interactive segment includes an audio element (1208). If it does, the client device 802 can check if the audio element is currently active (1210). For example, the audio element can be part of a video that must be activated by a user. In this case, the audio element may not be active. If the audio element is active, the client device 802 can wait for the audio element to complete playback (1212). Once the audio element has completed playback, or if an audio element was not active, the client device 802 can play an audio bumper content item (1214). The audio bumper content item can be played concurrently with the visual element of the interactive segment.

After presenting the bumper content item, the client device 802 can wait for the bumper content item to complete playback. Once the bumper content item completes playback, the client device 802 can present an audio element of a next media item within the audio stream (1216). The presentation of the audio element of the next media item can occur simultaneously with the visual element of the interactive segment. Once the interactive segment terminates, such as through a user taping an exit button or expiration of a specified time interval, a visual element corresponding to the currently playing media item can be presented within the visual stream.

In some cases, the invitational content package can terminate without the occurrence of an interactive segment triggering event (1218). For example, the invitational content package can terminate upon completion of a predefined period of time, completion of an audio or video segment, or a user initiated exit. In this case, the media channel can continue playback with a next media item, without presenting an interactive segment or a bumper content item. After presenting an audio element of a media item within the media channel or determining that the invitational content package has terminated, the client device 802 can resume previous processing, which can include repeating method 1200.

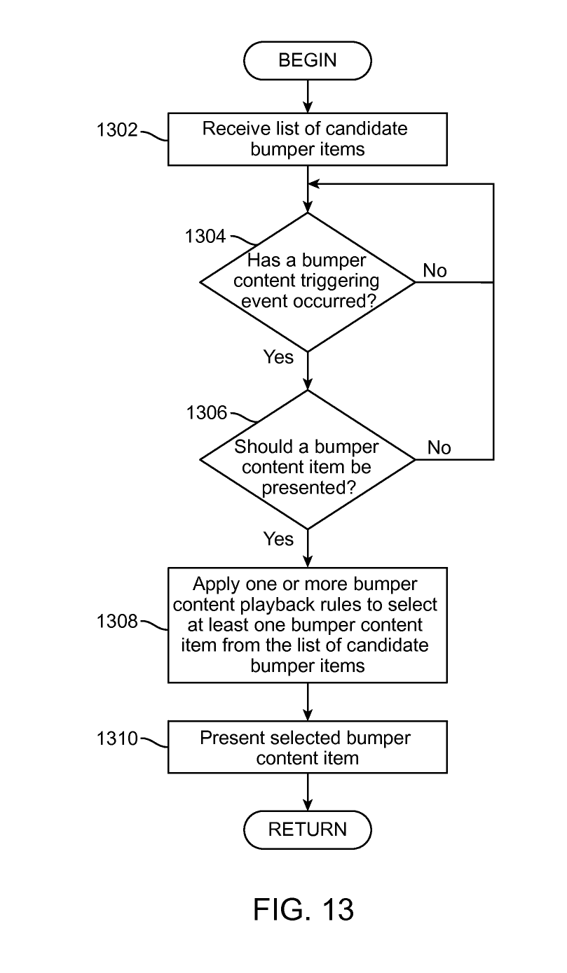

As described above, playing a bumper content item can include selecting a bumper content item for the bumper content slot. FIG. 13 is a flowchart illustrating steps in an exemplary method 1300 for selecting a bumper content item for playback within a media channel. For the sake of clarity, this method is discussed in terms of an exemplary client device 802 in FIG. 10. Although specific steps are shown in FIG. 13, in other embodiments a method can have more or less steps than show.

The client device 102 can receive a list of candidate bumper content items (1302), such as from a bumper content server 810. The list of candidate bumper content items can specify an identifier for one or more bumper content items that are candidates for playback on a media station. Additionally, each bumper content item identifier can be associated with metadata describing the bumper content item. In some cases, the list can be an update or a refresh of the list of candidate bumper content items.

At some point during the playback of the media station, the client device 802 can check if a bumper content triggering action has occurred (1304). A bumper content triggering action can occur at various times, such as when an interactive segment triggering event occurs or when a first element of an interactive segment completes playback but a second element of the interactive segment is still active. For example, when an audio element completes but the visual element is still active within the visual stream.

If a bumper content triggering event has been detected, the client device 802 can apply one or more invitational content playback rules to determine whether a bumper content item should be presented (1306). For example, a bumper content rule can be applied to determine whether sufficient time has passed since a first bumper content item has been presented. If it is determined that an invitational content item should not be presented at the current time, the client device 802 can wait for the detection of a next triggering event. However, if an bumper content item should be presented, the client device 802 can select at least one bumper content item from the list of candidate bumper content items, such as by applying one or more bumper content playback rules to the list of candidate bumper content items (1308), and add it to the content stream (1310). In some cases, the client device 802 can identify more than one bumper content item that is currently eligible for playback. In the event that only a single bumper content item is required at the particular time, a best-fit bumper content item can be selected. After adding the selected invitational content to the content stream for playback on the media station, the client device 102 can resume previous processing, which can include repeating method 800.

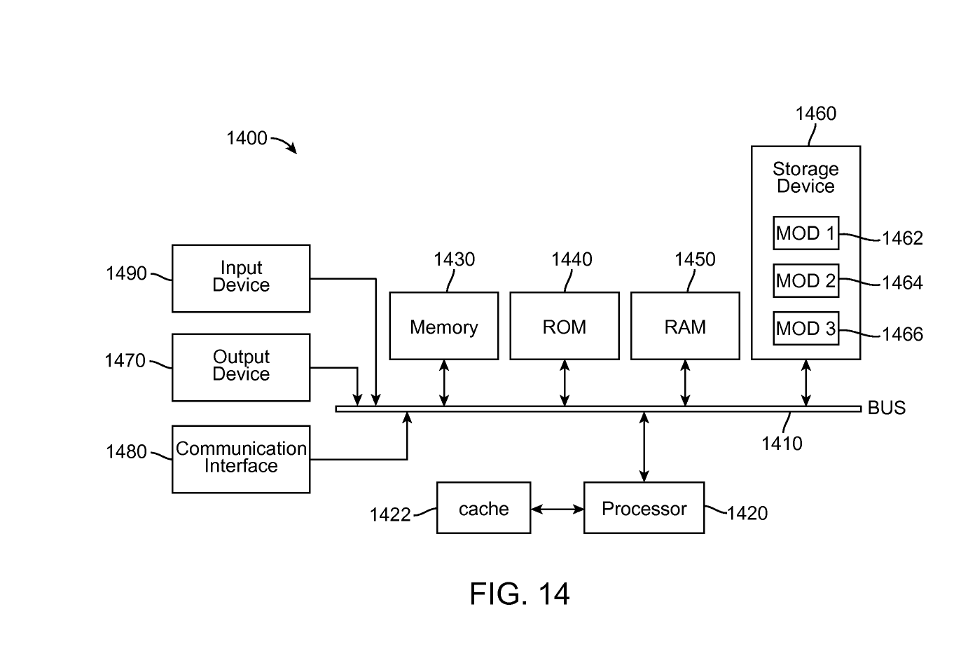

With reference to FIG. 14, an exemplary system 1400 includes a general-purpose computing device 1400, including a processing unit (CPU or processor) 1420 and a system bus 1410 that couples various system components including the system memory 1430 such as read only memory (ROM) 1440 and random access memory (RAM) 1450 to the processor 1420. The system 1400 can include a cache 1422 connected directly with, in close proximity to, or integrated as part of the processor 1420. The system 1400 copies data from the memory 1430 and/or the storage device 1460 to the cache for quick access by the processor 1420. In this way, the cache provides a performance boost that avoids processor 1420 delays while waiting for data. These and other modules can control or be configured to control the processor 1420 to perform various actions. Other system memory 1430 may be available for use as well. The memory 1430 can include multiple different types of memory with different performance characteristics. It can be appreciated that the disclosure may operate on a computing device 1400 with more than one processor 1420 or on a group or cluster of computing devices networked together to provide greater processing capability. The processor 1420 can include any general purpose processor and a hardware module or software module, such as module 1 1462, module 2 1464, and module 3 1466 stored in storage device 1460, configured to control the processor 1420 as well as a special-purpose processor where software instructions are incorporated into the actual processor design. The processor 1420 may essentially be a completely self-contained computing system, containing multiple cores or processors, a bus, memory controller, cache, etc. A multi-core processor may be symmetric or asymmetric.

The system bus 1410 may be any of several types of bus structures including a memory bus or memory controller, a peripheral bus, and a local bus using any of a variety of bus architectures. A basic input/output (BIOS) stored in ROM 1440 or the like, may provide the basic routine that helps to transfer information between elements within the computing device 1400, such as during start-up. The computing device 1400 further includes storage devices 1460 such as a hard disk drive, a magnetic disk drive, an optical disk drive, tape drive or the like. The storage device 1460 can include software modules 1462, 1464, 1466 for controlling the processor 1420. Other hardware or software modules are contemplated. The storage device 1460 is connected to the system bus 1410 by a drive interface. The drives and the associated computer readable storage media provide nonvolatile storage of computer readable instructions, data structures, program modules and other data for the computing device 1400. In one aspect, a hardware module that performs a particular function includes the software component stored in a non-transitory computer-readable medium in connection with the necessary hardware components, such as the processor 1420, bus 1410, output device 1470, and so forth, to carry out the function. The basic components are known to those of skill in the art and appropriate variations are contemplated depending on the type of device, such as whether the device 1400 is a small, handheld computing device, a desktop computer, or a computer server.

Although the exemplary embodiment described herein employs the hard disk 1460, it should be appreciated by those skilled in the art that other types of computer readable media which can store data that are accessible by a computer, such as magnetic cassettes, flash memory cards, digital versatile disks, cartridges, random access memories (RAMs) 1450, read only memory (ROM) 1440, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 1400, an input device 1490 represents any number of input mechanisms, such as a microphone for speech, a touch-sensitive screen for gesture or graphical input, keyboard, mouse, motion input, speech and so forth. An output device 1470 can also be one or more of a number of output mechanisms known to those of skill in the art. In some instances, multimodal systems enable a user to provide multiple types of input to communicate with the computing device 1400. The communications interface 1480 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 1420. The functions these blocks represent may be provided through the use of either shared or dedicated hardware, including, but not limited to, hardware capable of executing software and hardware, such as a processor 1420, that is purpose-built to operate as an equivalent to software executing on a general purpose processor. For example the functions of one or more processors presented in FIG. 41 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 1440 for storing software performing the operations discussed below, and random access memory (RAM) 1450 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 1400 shown in FIG. 14 can practice all or part of the recited methods, can be a part of the recited systems, and/or can operate according to instructions in the recited non-transitory computer-readable storage media. Such logical operations can be implemented as modules configured to control the processor 1420 to perform particular functions according to the programming of the module. For example, FIG. 14 illustrates three modules Mod1 1462, Mod2 1464 and Mod3 1466 which are modules configured to control the processor 1420. These modules may be stored on the storage device 1460 and loaded into RAM 1450 or memory 1430 at runtime or may be stored as would be known in the art in other computer-readable memory locations.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

We claim:

1. A computer implemented comprising:
presenting an invitational content package within a media channel, the invitational content package configured to be responsive to at least one interactive segment triggering event, the presenting delaying playback of a media item within the media channel;
responding to an occurrence of the interactive segment triggering event by playing an invitational content interactive segment within the media channel; and
prior to playback of the media item, presenting a first bumper content item, wherein the first bumper content item is presented concurrently with at least a portion of the invitational content interactive segment.

2. The computer implemented method of claim 1, wherein the media item is configured to include a media item audio element and a media item visual element, wherein the media item audio element and the media item visual element can be played as separate elements.

3. The computer implemented method of claim 2, wherein playing the invitational content interactive segment includes concurrently playing a visual element of the invitational content interactive segment and the media item audio element, wherein playing the media item audio element occurs after completing playback of the first bumper content item.

4. The computer implemented method of claim 3, wherein presenting the visual element of the invitational content interactive segment delays playback of the media item visual element.

5. The computer implemented method of claim 1, further comprising:
responding to an occurrence of an audio element triggering event within the invitational content interactive segment by playing an interactive segment audio element, the playing of the interactive segment audio element pausing playback of a media item audio element currently playing within the media channel.

6. The computer implemented method of claim 5, further comprising:
resuming playback of the media item audio element upon termination of playback of the interactive segment audio element.

7. The computer implemented method of claim 6, further comprising:
prior to resuming playback of the media item audio element, presenting a second bumper content item.

8. A manufacture comprising:
a non-transitory computer-readable storage medium; and
a computer executable instruction stored on the non-transitory computer-readable storage medium which, when executed by a computing device, causes the computing device to perform a method comprising:
detecting an occurrence of an interactive segment triggering event within an invitational content package currently presented within a media channel;
presenting an invitational content interactive segment within the media channel, the invitational content interactive segment associated with the invitational content package;
in response to detecting a bumper content triggering event, presenting a bumper content item within the media channel, the presenting occurring prior to playback of a next media item within the media channel and concurrently with at least an element of the invitational content interactive segment.

9. The manufacture of claim 8, wherein presenting a bumper content item further comprises:
applying one or more bumper content item playback rules to a list of bumper content items to select a bumper content item; and
presenting the selected bumper content item within the media channel.

10. The manufacture of claim 9 further comprising:
updating the list of candidate bumper content items in response to detecting a number of bumper content items in the list falling below a predefined threshold value.

11. The manufacture of claim 9 further comprising:
updating the list of candidate bumper content items in response to detecting a change in the media channel.

12. The manufacture of claim 9, wherein the bumper content triggering event includes at least one of detecting an occurrence of an interactive segment triggering event within an invitational content package currently presented within a media channel or detecting a completion of a first element of the invitational content interactive segment while a second element of the invitational content interactive segment continues playback.

13. The manufacture of claim 12, wherein the first element of the invitational content interactive segment is an audio element and the second element of the invitational content interactive segment is a visual element.

14. The manufacture of claim 9, wherein presenting the invitational content interactive segment includes concurrently presenting a visual element of the invitational content interactive segment and an audio element of the media item, wherein presenting the audio element of the media item occurs after presenting the bumper content item.

15. A system comprising:
a processor;
a communications interface configured to receive a content stream, the content stream including a mix of media items and invitational content packages;
a first module configured to control the processor to present an invitational content package from the content stream within a media channel, the presenting delaying playback of a media item from the content stream;
a second module configured to control the processor to detect an occurrence of an interactive segment triggering event within with the invitational content package;
a third module configured to control the processor to present an invitational content interactive segment, wherein the presenting is in response to detecting the occurrence of the interactive segment triggering event; and
a fourth module configured to control the processor to play a bumper content item, playing the bumper content item delaying playback of at least a portion of the media item, wherein the bumper content item is presented concurrently with at least a portion of the invitational content interactive segment.

16. The system of claim 15, wherein the at least a portion of the media item is a media item audio element.

17. The system of claim 16, wherein playback of the media item audio element occurs concurrently with a visual element of the invitational content interactive segment.

18. The system of claim 15, wherein the media channel is curated and the bumper content item is specified by a sponsor of the media channel.

19. The system of claim 15, wherein the bumper content item is selected based on at least one of user characteristic data, the invitational content package, the media item, or the media channel.

20. The system of claim 15, wherein presenting the bumper content item is based on at least one bumper content playback rule.

21. The system of claim 20, wherein the at least one bumper content playback rule specifies a minimum time period between presenting a first bumper content item and a second bumper content item.

22. The system of claim 20, wherein the interactive segment triggering event includes at least one of a tap, a click, a predefined movement of a client device, or an audio command.

23. A computer implemented method comprising:
caching a list of bumper content items corresponding to a media channel, each bumper content item in the list of bumper content items associated with metadata descriptive of the bumper content item;
in response to detecting an occurrence of a bumper content triggering event, applying at least one bumper content playback rule to the list of bumper content items to identify at least one bumper content item; and
presenting the selected bumper content item within a media channel, the presenting delaying playback of at least a portion of a next media item, wherein the bumper content item is presented concurrently with an element of an invitational content interactive segment.

24. The computer implemented method of claim 23, wherein a bumper content triggering event is at least one of detecting the occurrence of an interactive segment triggering event corresponding to an invitational content package presented within the media channel or detecting a completion of a first element of the invitational content interactive segment while a second element of the invitational content interactive segment continues playback.

25. The computer implemented method of claim 23 further comprising:
receiving the cached bumper content playlist from a bumper content server, the bumper content playlist specific to the media channel, wherein each bumper content item in the bumper content playlist satisfying one or more bumper content playlist generation rules applicable to the media channel.

26. The computer implemented method of claim 25, wherein at least one of the one or more bumper content playlist generation rules is based on user characteristics.

27. The computer implemented method of claim 23, wherein at least one of the one or more bumper content playback rules is media channel independent.

28. The computer implemented method of claim 23, wherein the media channel is curated, and wherein at least one of the one or more bumper content playback rules is specified by the sponsor of the media channel.

29. The computer implemented method of claim 23, wherein the list of bumper content items includes bumper content targeted to the client device.

30. The computer implemented method of claim 23, wherein the media channel has associated metadata, the metadata descriptive of the media channel.

31. The computer implemented method of claim 30, wherein at least one of the one or more bumper content rules matches bumper content metadata with the media channel metadata.

32. The computer implemented method of claim 23, wherein at least one of the one or more bumper content rules matches bumper content metadata with metadata associated with the next media item.
